(19) United States
(12) Patent Application Publication
(10) Pub. No.: US 2011/0115930 A1
(43) Pub. Date: May 19, 2011

(54) IMAGE MANAGEMENT SYSTEM AND METHOD OF SELECTING AT LEAST ONE OF A PLURALITY OF CAMERAS

(76) Inventors: Joseph M. Kulinets, North Andover, MA (US); Peter R. Nuytkens, Melrose, MA (US)

(21) Appl. No.: 12/620,489

(22) Filed: Nov. 17, 2009

(51) Int. Cl. H04N 5/232

(52) U.S. Cl. 348/211.2; 348/E05.042

(57) ABSTRACT

A media management system and method of selecting at least one of a plurality of cameras is described. The system includes a plurality of image-taking systems, each one including a camera having a plurality of control functions; and a camera control unit for controlling operation of the camera. The control unit includes a communication unit for communicating with the plurality of image-taking systems and a mobile communication device, the communication unit establishing an image capturing session with the mobile communication device in response to an initiation by the mobile communication device; and a processor that uses a location of the mobile communication device to select at least one image-taking system from the plurality of image-taking systems. The control unit transfers at least one of the plurality of control functions to the mobile communication device, and the mobile communication device operates the camera to capture at least one image.

### BACKGROUND

1. Technical Field

The present disclosure relates generally to image management systems. In particular, the present disclosure relates to an image management system and method of selecting at least one of a plurality of cameras.

2. Description of Related Art

Digital photography uses digital technology to make images of subjects, that can be displayed, printed, stored, manipulated, transmitted, and archived using digital and computer techniques. The public has embraced this technology thanks in part to the many technological advances that has occurred and continues to occur.

However, digital photography, with all its advances, continues to face obstacles. For example, it is often difficult or practically impossible to take an image of the subject in certain settings, such as museums, which often prohibit the taken of photos and videos; water parks, when the subject is sliding in a water slide; a skier in a lift chair or during a jump. Other examples include, difficult to reach spots or spots from unusual perspectives, etc.

Another common problem arises when, for example, a person is unaccompanied or when a group of persons want to capture a photograph the group. In these situations, it is necessary to use a tripod or asking a bystanders for help since current devices are designed to be manually operated with a user behind the camera device.

Although many camera manufacturers include a remote unit to operate the camera device remotely, setting up the camera device for using these accessories is cumbersome and often requires external accessories. Various solutions have been proposed, for example, in sightseeing spots such as a museum, an amusement park and a theme park, services are provided for selling a print of an image of a customer photographed during an attraction. In particular, many locations have installed photography systems for taking pictures that customer would not be otherwise permitted to or able to take. However, these systems permit no input from the customer as to the characteristics of the image. That is, the customer has no control over the capturing of the image. In addition, these systems require a registration by a customer. The registration process requires, inter alia, personal identifying information from a customer. This identifying information is stored and later associated with an image. In other examples, the system automatically, and often times randomly, captures images of the customer and later associates the image data to the identifying information. Sometimes, the image data obtained throughout the session is stored together with the identifying information of the customer.

The present disclosure is directed to image management system and method of selecting at least one of a plurality of cameras using a mobile communication device that requires no registration by the customer.

### SUMMARY

The present disclosure is directed to an image management system and method of selecting at least one of a plurality of cameras using a mobile communication device. In one embodiment, a media management system is described. The system includes a plurality of image-taking systems and a system control unit. Each one of the image-taking systems includes: a camera having a plurality of control functions, and a camera control unit for controlling operation of the camera. The system control unit includes a communication unit for communicating with the plurality of image-taking systems and a mobile communication device, the communication unit establishing an image capturing session with the mobile communication device in response to an initiation by the mobile communication device; and a processor that uses a location of the mobile communication device to select at least one image-taking system from the plurality of image-taking systems. The control unit transfers at least one of the plurality of control functions to the mobile communication device, and the mobile communication device operates the camera to capture at least one image. The camera control unit streams images captured by the selected camera to the mobile communication device.

In one embodiment, at least one of the plurality of image-taking systems includes a display device that displays an access code, the communication unit establishing the image-capturing session when the mobile communication device transmits the access code to the camera control unit.

The camera control unit creates a media file by associating an identifier associated with the mobile communication device with at least one image captured by the camera of the selected image-taking system, the camera control unit then transmits the media file to a server. A media output terminal then receives from a customer the identifier associated with the mobile communication device; retrieves the media file corresponding to the identifier from the server; and transfers media from the media files to at least one of a printer, a storage media device and a computing device.

In one particular embodiment, the camera is mounted to an adjustable platform, the camera control unit controlling operation of the adjustable platform. In such instance, the camera control unit transfers control of the adjustable platform to the mobile communication device.

The system control identifies the location of the mobile communication device and further wherein the communication unit transmits the location of the mobile communication device to the image-taking system. In one embodiment, the system control determines the location of the mobile communication device via one of global positioning system and triangulation.

The control functions of the camera include at least one of zoom, pan, tilt, media capture, and time-elapse media capture. In some embodiments, the mobile communication device creates an audio file, wherein the audio file is associated with the at least one image. In such embodiment, the camera control unit generates a media file, the media file including the at least one image, an audio file and an identifier corresponding to the mobile communication device.

The camera may record a still image (i.e. a photograph) or a moving image (i.e. a video or movie). The mobile communication device is a cellular-enabled wireless device.

A method of controlling an image capturing device is also described. The method includes establishing, by a mobile communication device, an image capturing session with a system control unit; selecting, by the system control unit at least one of a plurality of image-taking systems. Each o image-taking system includes a camera having a plurality of control functions, and a camera control unit for controlling operation of the camera. The method further includes transmitting, by the mobile communication device information about its exact location; directing the camera towards the location of the mobile communication device; transmitting, by the camera control unit, to the mobile communication device control functions for controlling operation of the camera; capturing, by the camera, at least one image in response to operation by the mobile communication device; and creating, by the image capturing system, a media file, the media file having the at least one image and an identifier associated with the mobile communication device.

The method further includes streaming, by the camera control unit, the at least one image to the mobile communication device, prior to capturing the at least one image; transmitting, by the image capturing system, the media file to a server, and retrieving, by an output terminal, the media file from the server, in response to an initiation session.

Other aspects, features and advantages of the presently disclosed image management system and methods selecting at least one of a plurality of cameras using a mobile communication device will become apparent from the following detailed description taken in conjunction with the accompanying drawing, which illustrate, by way of example, the presently disclosed system and method.

### BRIEF DESCRIPTION OF THE DRAWINGS

The features of the presently disclosed image management system and method will be described in detailed herein below with references to the figures, wherein:

FIG. 1 illustrates an exemplary top-level block diagram of an image management system, in accordance with one embodiment of the present disclosure;

FIG. 2 illustrates a block diagram of an image-taking system, in accordance with one embodiment of the present disclosure;

FIGS. 3A, 3B and 3C illustrate the positioning of a camera of the image taking system relative to a group of customer, in accordance with the present disclosure;

FIG. 4 illustrates a top view of a location having the image taking system of the present disclosure;

FIG. 5 illustrates an exemplary data sheet stored in the system control unit of the image taking system of the present disclosure;

FIG. 6 is an exemplary block diagram of a media output terminal, in accordance with the present disclosure;

FIG. 7 is an exemplary photo output of the media output terminal of FIG. 6; and

FIG. 8 is an exemplary flow diagram of method of selecting at least one of a plurality of cameras using a mobile communication device, in accordance with the present disclosure.

### DETAILED DESCRIPTION

Referring now to the drawing figures, wherein like references numerals identify identical or corresponding elements, an embodiment of the presently disclosed media management system and method will be described in detail.

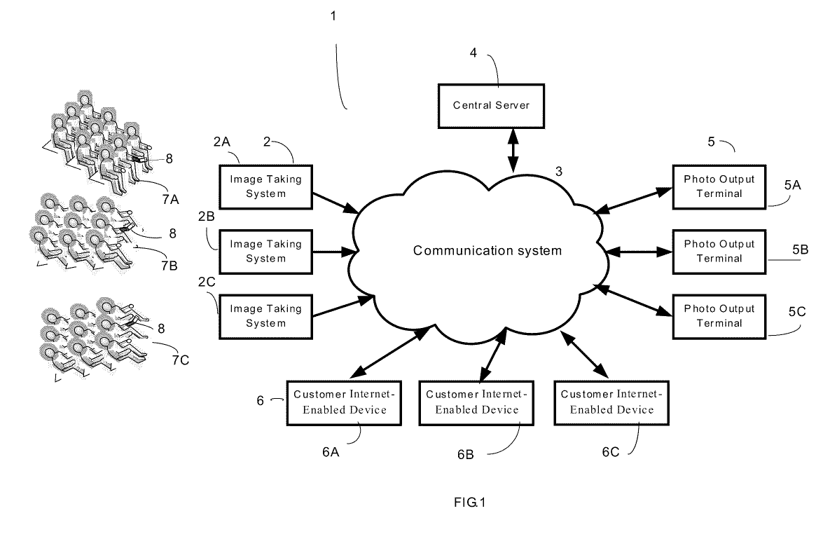

FIGS. 1-6 illustrate a media management system and method for controlling the taking of the image. In particular, a plurality of image taking systems are installed at strategically predetermined locations. Each image taking system is in communication with a image-capturing device.

In one embodiment, the image management system combines a multiplicity of image taking systems serving for photographing a customer, for example, as a spectator of a sport game, sport competition, or concert. The image system is installed at such facilities as a stadium, race tracks, concert halls or any other facilities having numbered seats, and can spread over many of such facilities distantly located from one another. Thus, one image management system can manage the images taken in different time and in different places across the country or even across the globe.

Each image taking system combines many digital cameras each connected to a related camera control means, and placed on the digitally controlled rotating platform. The rotating platform is configured to change the tilt and rotation angle (pan) of the digital camera. In addition, the camera control means also controls the zoom and the actual taking of the picture of its corresponding digital camera. These actions are performed based on the data received from the system control unit.

All together, the field of view of all the combined digital cameras (i.e. all possible tilt and pan angles) includes every single seat in the location where the service of the present image taking system is offered. Here the directional angle is an angle under which the particular camera is directed to. For example, the directional angle may be close to the perpendicular or differs from this direction by no more than approximately 40 degrees.

In accordance with the present disclosure, a customer eager to be serviced by the image management system would have a mobile communication device, such as, for example, cellular phone or a cellular-enabled wireless communication device, such as, for example, a notebook or PDAs. A mobile communication device, as the term is used through the present disclosure, also includes mobile computing devices. Thus, in operation, when a customer or a group of customers want their picture taken, one of the customers takes the leading role as a “manager” composing the group and later controlling the zoom, tilt and angular rotation of the camera, and the moment of taking the photo. Using a cell phone, the customer will dial a cellular number designated to the system control unit. In one embodiment, the cellular phone number is displayed on the display unit connected to the camera control means. In another embodiment, the cellular number is written on a special sign or it is displayed proximate to the visually distinguished marks. Using the mobile communication device, the customer dials the designated cellular number, where identifier information corresponding to the mobile communication device is identified using the “caller ID” function of the system control unit. The identifier information is stored in the system and is temporally associated with an image taking session.

As the session is initialized, the customer is urged to set up an alphanumeric password, this password is stored and associated with the mobile communication device for later accessing the images taken by the image-capturing device. After the customer establishes a password, the customer is asked to enter its location, e.g. the sector, row number and/or the seat number and the number of the adjacent seats that the customer wants included in the photograph.

Based on this information, the system control unit determines the camera that is best positioned to take the image. To do this the system control unit has a pre-determined table, where each seat at the facility is pre-assigned to one or a few cameras. Since the number of cameras in a particular image taking system is limited, and the number of the customers simultaneously making a request for their images to be taken can be significant, the system control unit can organize and support a queue of customers to each digital camera. Thus, upon receiving a request for image taking from a second customer, the system control unit checks if there is a line to the required camera. If a line exists, the system puts the customer into this line, storing all required information (i.e. the customer cellular number and the customer's location information). If the camera is available, or the previous image taking session for this camera is finished, the second customer is serviced by the camera.

Based on the information regarding the adjacent seats in proximity to the customer's location, the system control unit determines for the designated camera the required pan angle, tilt angle, and zoom (i.e focal length) information. Each camera is pre-calibrated according to this information. Thus, the image taken shows the zoom image of the specified seats.

To set the camera into required position the pan and tilt angles data are transferred from the system control unit through the second and first communication means to the corresponding camera control means. The zoom data is also transferred from the system control unit via communication means to the corresponding camera control means, which controls the zoom of the digital camera.

After setting the rotating platform and the camera into desired state, the camera control means start the constant transmission of the image as the camera sees it from the camera to the display of the mobile communication device. In addition, certain control functions of the camera and the rotating platform is transferred to the mobile communication device. Thus, the customer is provided with a table, which correlates particular buttons on the mobile communication device to particular control functions of the camera. The table is sent through a cellular phone network and can be displayed at the display unit of the mobile communication device. In one embodiment, the correlation can be assigned as follows:

1—Zoom out;

### 3—Zoom in;

4—Pan left;
6—Pan right;

### 2—Tilt up;

5—Tilt down;

### 0—Shoot;

*—Shoot after 3 seconds of delay, etc.

As well known in the art, upon pressing the “shoot” button, the picture is taken. Upon pressing of any button assigned to the “shoot after delay” function, the picture will be taken after the specified delay. The function “shoot after delay” function is very useful to give to the customer some time to, for example, remove the mobile communication device from the field of vision of the camera.

After the image is taken, the camera control unit generates a media file. The media file includes the image merged with the identifier information corresponding to the mobile communication device. The media file is then transferred, by the camera control unit, to the remote server via a cellular connection, such as, for example 3G or 4G connection. The server then creates an index according to the mobile communication device. If, for example, the customer uses the same mobile communication device in different image taking systems positioned at different locations, the images taken by all of these image-taking systems will be stored in a database on the same server and associated with the same identifier information of the mobile communication device. The term “media”, as this term is used throughout the present disclosure is defined as “photography or data related to video and audio information” or the means of distribution thereof.

In another embodiment, the mobile communication device may create and transmit an audio message through the cellular phone connection to the camera control unit, where it will be stored as an audio file. The audio file can then be appended to the media file.

The customer can retrieve the media file from any Internet-enabled device, such as computer, smart phone, etc. The order can be placed for the purchase of photo prints, storage media (such as CD or DVD), or transfer the media files to an internet-enabled device.

To place an order the customer goes on the Internet to the image management system website and logs in using as a user name the identifier information of the mobile communication device used during taking the images. During the log in procedure the customer is asked to enter the alphanumeric password, upon entering which the customer receives the possibility to proceed with the order.

In response to the customer request to retrieve the media file, the server searches for all images and/or media files associated with the identifier information provided. In one embodiment, the server creates a low-resolution image file for each image stored and transfers it to the customer for review.

Using the image ordering software system of the server the customer places the order and pays for it using the credit card or any other remote payment system. For each file ordered as a print the customer can perform some editing of the image, creating the final photo to be printed. Any additional information related to the place where the photo picture was taken can be added to the final prints, or incorporated into the image files.

In another embodiment, the ordering of the media files can be made, for example, at the exits of museums, parks, etc, where the payment and fulfillment the order can be performed by the terminal in real time.

With initial reference to FIG. 1, an embodiment of an image management system and method of selecting at least one of a plurality of cameras, in accordance with the present disclosure, is illustrated and is designated generally as image management system 1. Image management system 1 includes a plurality of image taking systems 2A, 2B and 2C connected to a communication system 3 (e.g. the internet) via cellular communication means (not shown) using, for example, communication protocols such as 3G, 4G, etc. Communication system 3 facilitates the transfer of data between image taking systems 2, server 4, photo output terminal 5A, 5B and 5C and customer internet-enabled device 6A, 6B and 6C.

Media taking systems 2A, 2B and 2C may be installed at strategically selected spots across at least one place of interest, such as a tourist attraction (e.g. amusement, theme, water or nature park, botanical garden, museum, architecture ensemble, monument, or other tourist attractions, outing site, function hall or guided tour bus). Thus, one image management system 1 can manage the images taken in different time and in different places across the country or even across the world.

Image management system 1 further includes a plurality of media output terminals 5A, 5B, 5C, which can be placed, for example, at the places of interest, for example, at the exits of museums, parks, etc., and are used to place the order for prints or files on particular storage media, where the payment and fulfillment of the order can be performed by the terminals 5A, 5B and 5C in real time.

In accordance with the present disclosure, a customer 7 or a plurality of customers 7A, 7B and 7C can control operation of the image-taking system 2A, 2B and 2C via a mobile communication device 8. Mobile communication device 8 can be any one of a cellular-enabled wireless device such as a cell phone.

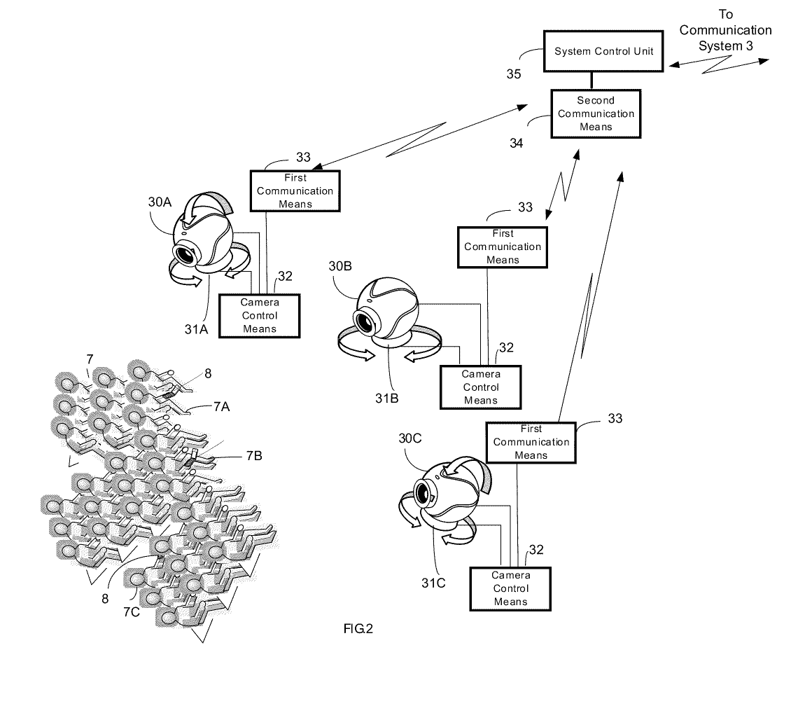

With reference to FIG. 2, the image taking system 2 comprises a multiplicity of digital cameras 30A, 30B and 30C (collectively “30”), each connected to a corresponding camera control means 32, and positioned on a digitally controlled rotating platform 31. Rotating platform 31 is able to change the tilt and rotation angle (pan) of the digital camera 30. In addition to the tilt and pan, the camera control means 32 also control the zoom and moment of taking pictures of corresponding digital camera 30. A camera is any device that records images, either as a still photograph or as moving images known as videos or movies.

Camera 30 together with the digitally controlled rotating platforms 31 are mounted at a strategically chosen spots through the stadium, concert hall, etc., and the cameras are aimed towards the particular group of spectator's seats. In most cases such strategically selected spots will be directly under the ceiling or at the light towers, etc. Each digital camera 31 is connected to camera control means 32, which may be a conventional microprocessor system.

The camera control means 32 are running under the control of an embedded software (not shown) which among other functions, controls the zoom and shoot actions of the digital camera 30, pan and tilt angles of the rotating platform 31, as well as provides the possibility of reading the file representing the image taken out of the digital camera 30. Cameral control means 32 also have the ability to communicate via first communication means 33 and second communication means 34 with system control unit 35. First communication means 33 are connected with the second communication means 34 through wired or wireless communication channels. In accordance with the present disclosure, the camera control means 32 can read from the digital camera 30, inter alia, a media file containing the taken image and transmit the media file through the first communication means 33 and second communication means 34 to a data base server 4 using, for example, 3G, 4G, IP or similar protocols.

System control unit 35 is connected through the communication system and Internet to central server 4. Moreover, the system control unit 35 has the ability to receive cellular phone originated calls through the communication system 3.

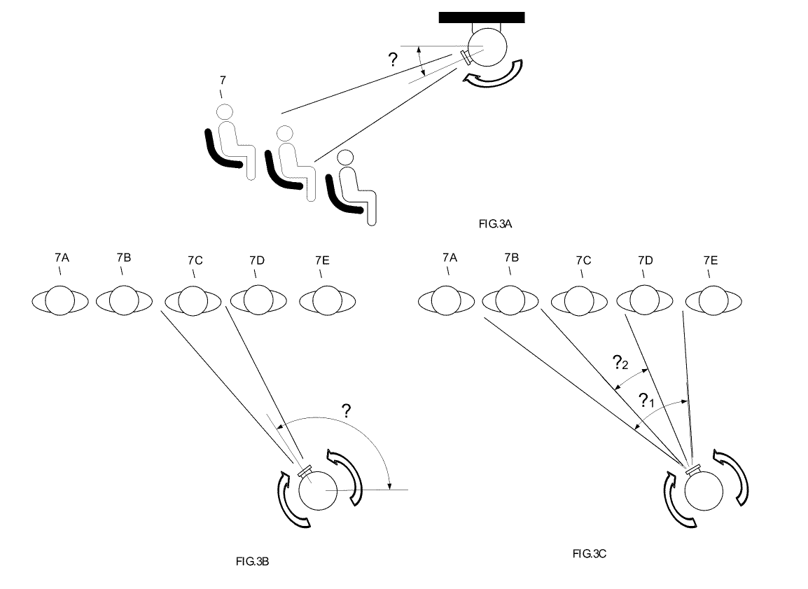

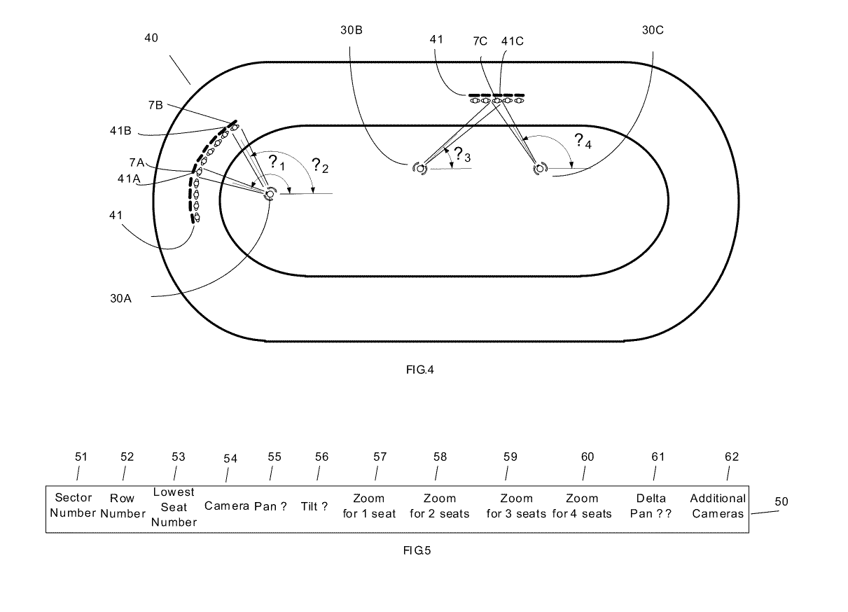

With reference to FIGS. 3A, 3B, 3C, the positioning of digital cameras 30, according to the current invention, will be described. With particular reference to FIG. 3A, a side view of spectator's seats in a particular facility, such as a stadium or concert hall, relative to camera 30, is illustrated. The camera 30 is mounted on the rotating platform 31, which is fixed to a building or a lighting tower, etc. The spectator seating is organized in rows, where in most cases the rear row will be placed somewhat higher that the row in front of it. The rotating platform 31 has the ability to change the tilt angle φ under the control of the camera control means (not shown on the figure). By changing the tilt angle φ the digital camera 30 can be aimed at the spectators sitting in the required row.

With particular reference to FIG. 3B, a top view of the group of the spectators 7A-7E, all sitting in the same row of seats, is illustrated. By changing the pan angle α of the rotating platform 31(not shown in this figure) the digital camera 30 can be panned directly onto required seat (of spectator 7C in FIG. 3B).

FIG. 3C illustrates another top view showing that by changing the angle of view β of the digital camera 30, which is done by zooming it in or out (changing the focal length of its lens) it is possible to change the field of view of the digital camera 30, creating the image, which has the required number of spectators sitting in the designated seats. Thus, by changing the angle of view β from the value β₁ to the value β₂ the number of the spectators at the final image is changed from three (e.g. spectators 7B-7D) to one spectator (e.g. 7C).

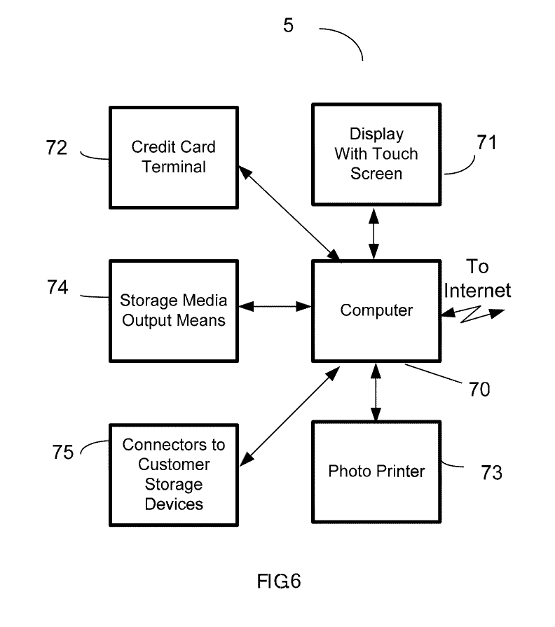

With reference to FIG. 4, many possible positioning of the cameras at a particular facility is envisioned. For example, FIG. 4 illustrates a top view of a stadium 40, where many digital cameras 30 are placed on the rotating platforms 31 (not shown) so as to cover all the rows of seats 41, where the customers 7 are sitting. All together, the combined fields of view of all digital cameras 30 taken together at all possible tilt and pan angles should cover at appropriate angles all the spectators' seats 41 wherever the service of particular image taking system 2 is offered. The term “appropriate angle” means that the angle under which any seat covered by the system, as viewed by at least one of the cameras, is close to the perpendicular plane of the seats and differs from this direction by no more than, for example, approximately 40 degrees. For example, as illustrated by the figure, in order to take an image of the spectator 7A sitting in seat 41A, camera 30A should have a pan angle equal to α₁, but to take an image of the spectator 7B sitting in seat 41B, camera 30A should have the pan angle equal to α₂.

If there is a significant number of seats which exceeds the potential number of images which can be served by one digital camera 30 during a particular event, it is possible to install additional cameras 30, such that one seat may be covered by the field of view of more than one digital cameras 30, as shown in the case of seat 41C. Thus, seat 41C is in the field of view of cameras 30B and 30C.

With continued reference to FIGS. 2-4, the method of taking the images with the image taking system 2, according to the current disclosure, will be described in detail. A customer or individual spectator 7 will have a mobile communication device (e.g. cellular-enabled wireless device 8) such as a cell phone, a notebook or PDAs, accessible to a “caller ID” function of the system control unit 35 of the image taking system 2.

Using the cellular phone 8, the customer dials a cellular number of the image taking system provide, for example, in a display unit. The customer 7 may be asked to set up the alphanumeric password for later retrieving of the images taken during this image taking session. Upon successful connection, the system control unit begins transmitting data, via the cellular communication network, to the cellular device of the customer. In addition, customer 7 is asked to enter the sector, row number, and the number of adjacent seats to be photographed. Based on this information, the system control units determines the best digital camera, which should be used to take the required photo image. To do this the system control unit has a pre-determined table, where each seat at the facility is pre-assigned to one or a few cameras, which can be used best to take an image of the seats required.

Because the number of the digital cameras 30 in particular image taking system 2 is limited, and the number of the customers simultaneously giving the request for their images to be taken can be significant, the system control unit 35 can organize and support a queue of customers to each digital camera 30. Upon receiving a request for image taking from the next customer 7, the system control unit checks if there is a line to the required camera. If a line exists, the system will check for another camera that can be used to take the requested image. If such camera exists (which is determined from the above table), the image will be taken using this camera. If there is no additional camera, or all possible cameras are busy, the system control unit 35 puts the customer 7 into the line for the particular camera 30, storing all required information, including the customer cellular number and its seat information.

If the camera is not busy, or the previous image taking session for this camera is finished, the system control unit takes the first customer from the line to this camera. Based on the information regarding the adjacent seats occupied by the next party to be photographed, the system control unit determines for the assigned digital camera required pan angle, tilt angle, and zoom (focal length) information (determining the camera's angle of view). Each camera is pre-calibrated relative to this information, and all these data are stored in the special table in the system control unit. If the camera's pan, tilt and angle of view will be set according to this table, the image taken will show the zoomed image of the required adjacent seats. An example of a possible structure of such table is shown in FIG. 5.

With reference to FIG. 5, the records 50 in this table are indexed with the sector number 51, row number 52 and seat number 53, or with any other enumeration systems used for the assignment of seats at a particular facility. In one embodiment, the seat number refers to the lowest seat number if the spectators sitting in a few adjacent seats are supposed to be photographed. For example, for the seat 41A in FIG. 4, table 50 contains fields describing the camera 30A, which can be used to take the image of the designated seat 41A (field 54), pan angle α₁ (field 55), at which the camera 30A should be aimed in horizontal direction, and tilt angle φ—in vertical direction. Fields 59-61 in the record 50 describe the angle of view (or zoom, or focal length) required to be set for camera 30A to be zoomed directly in seat 41A, or seat 41A and additional 1, 2 or 3 adjacent seats, accordingly. Field 62, called Delta Pan, sets the additional angle, which should be added to the value of the Pan angle 55 to accommodate each additional person in the frame. For example, to take the image of 4 persons, the actual pan angle for the camera 30A is equal to the pan angle in field 55 plus the Delta Pan value from the field 61 multiplied by 3. The final field in the record 50, the field 62 is a flag, showing if there are other cameras (and other associated records), which can be used to take the same image comprising the same seats.

With continued reference to FIGS. 2-4, to set the camera 30 into required position the pan and tilt angles data are transferred from the system control unit 35 to the corresponding camera control means 32 of camera 30. Control means will then control rotating platform 31, setting it into the required position under required angles. The zoom data is also transferred from the system control unit 35 to the corresponding camera control means 32, which controls the zoom of the digital camera 30.

After setting the rotating platform 31 and the camera 30 into the appropriate position, the camera control means 32 start the constant transmission of the image, as seen by the camera 30, to a display of the cellular phone or a cellular-enabled wireless device 8. In addition, and simultaneously, the customer 7 acquires the ability to control certain functions of the rotating platform 31 and digital camera 30 via cell phone 8. In one embodiment, the control of the functions is to compensate for any discrepancies in the data table 50. In this particular embodiment, the customer is provided with the table, which assigns particular buttons on his cellular device 8 to the particular camera control functions. This table is sent through the cellular phone network to the cellular device 8. The examples of the assignment can include:

1—Zoom out;

### 3—Zoom in;

4—Pan left;
6—Pan right;

### 2—Tilt up;

5—Tilt down.

### 0—Shoot;

*—Shoot after 3 second delay, etc.

Upon pressing, for example, “*” button, which commands the camera to capture the image, the picture is taken. Upon pressing of any button assigned to the “shoot after delay” function, the image will be taken after the specified delay.

When the image is taken, the image file is read by camera control means 32 from the digital camera 30 and merged with the cellular phone number of customer, and, if any, the alphanumeric password for retrieving images, thus creating a media file.

The media file is then transferred by the control means 32 to the remote server 4 via communication system 3. Server 4 indexes the media file according to the associated identifier and accordingly stored in a database of server 4. If, for example, customer 7, uses the same mobile communication device a different image taking systems at different locations, the images taken by all of these image taking systems are stored in the database and associated with the same cellular phone number.

To accompany a still or video image with a voice message from the customer, the customer 7 can use a microphone (not shown) of mobile communication device 8 to transmit the audio message through the cellular phone communication to the camera control means 32, where it will be stored as an audio file. The audio file is then appended to the media file. The process of taking audio record is spread in time, and it starts with a press of the “shoot” button by the customer 7, and continues until this button will be pressed again or after the maximum time duration determined and controlled by the camera control means 32. During all this time the audio record is continually taken as the voice message, translated through the cellular phone communication and stored inside the camera control means 32.

In one embodiment, the image taking session is terminated by the customer 7, by, for example, hanging up. In another embodiment, the image-taking system 1 reaches a maximum predetermined number (e.g. 10) of images. In yet another embodiment, the session is terminated when a predetermined allotted time (e.g. 5 minutes) is reached. For video image and audio record taking there can be separate limitation on the maximum duration of video or audio taking time.

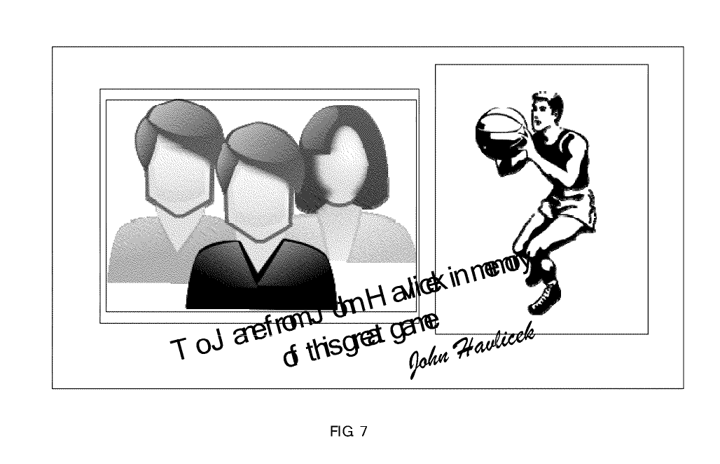

With reference to FIG. 6, an exemplary photo output terminal is illustrated. Photo output terminal 5 includes a computer 70 connected to communication system 3 and having special ordering, photo editing, and photo output software installed (not shown). Computer 70 includes a display 71 having input means such as a touch screen, and a credit card terminal 72 which accepts credit cards payments. A printer 73 is in communication with computer 70 for printing photo generated by the image-taking system. Storage media output means 74, e.g. a digital storage disc writer, are also connected to the computer 71 and provide the possibility to write the ordered images and video and audio files to the digital storage media. The computer 71 also has connectors to customer storage devices 75, which give customer 7 the ability to write the media files ordered to their own storage devices, such as USB sticks, memory cards, etc.

The customer 7 can begin a session with terminal 5 by, for example, touching screen of display 71. Customer 7 will be prompted to enter the identifier corresponding to the mobile communication device 8. If the alphanumeric password for retrieving images was setup during the dialog between the customer and the image taking system, this password should be provided.

The computer 71 creates a request containing all information entered by the customer, and transmits the request via the communication system 3, to the server 4. Upon receipt of the request, the server 4 then searches for all media files associated with the received identifier corresponding to the mobile communication device 8, and returns all the files retrieved to the computer terminal 70 according to the request.

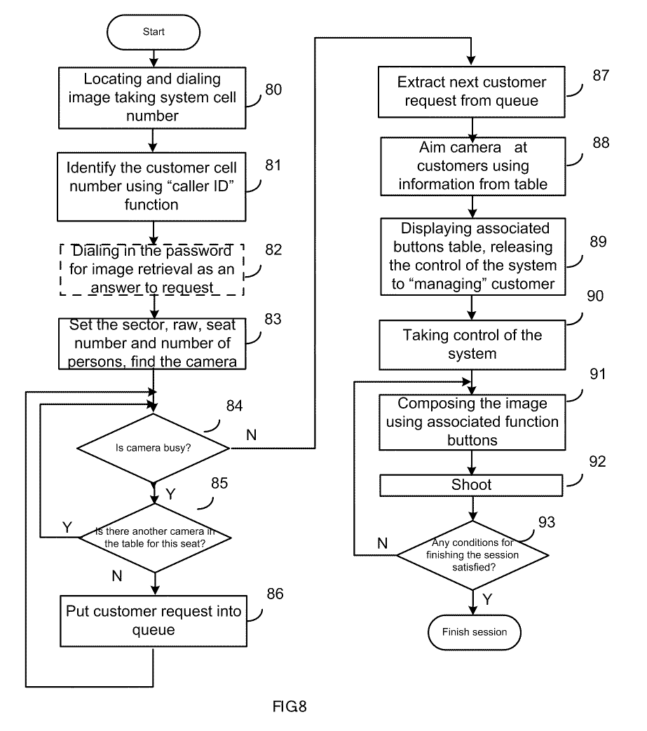

Working with the terminal 5 and using the appropriate software the customer 7 can edit the received photo images creating the final images to be printed, and order the photo prints in required sizes paying for them with her/his credit card using the credit card terminal 72. The photo prints ordered are printed at photo printer 73. The customer can also review the video images and images, which are accompanied by the recorded audio files and order the copies of all these files. These copies can be ordered on video discs using the storage media output means, or the customer can connect her/his own storage devices, such as USB sticks, memory cards, etc., to the connectors to customer storage devices 75 and receive the copies of the files ordered on her/his own device. The payment for all the files is done with the credit card using the credit card terminal 72. FIG. 7 illustrates an example of a picture.

Most often the customers of the image management system 1 will place the order through the internet. The order can be placed for the still images prints, or for the files with still images, or for the files with still images with accompanied audio files, or for video images files, or for video images files with accompanied audio files, where files can be either transferred through the Internet, or send to the ordering customer as the files on a particular storage media, such as audio or video discs, etc. The customer can do it from any Internet-enabled device, such as computer, cellular phone, etc. having an access to the Internet. The order can be placed for the purchase of photo prints, the storage media (such as CD or DVD) with the files containing the particular images taken, or just the transfer of these files to the customer internet-enabled device. To place the order the customer goes on Internet to the image management system website and logs in using as a user name a phone number of the cellular-enabled device 8, which was used during particular image taking session. If the alphanumeric password for retrieving images was setup during the dialog between the customer and the image taking system, this password should be provided.

With reference to FIG. 8, a method of operating an image-capturing device using a mobile communication device, in accordance with the present disclosure is described. In one embodiment, an image taking session starts when a customer 7 approaches the visually distinguished marks 30. At step 80, customer 7 locates and dials the cellular number established by the cellular modem 33 using a mobile communication device 8. At step 81, an identifier, such a the customer cell phone number, is identified using a “caller ID” function of the cellular modem 33. After establishing the connection, the image taking system 1 identifies and stores the cellular number of communication device 8. At step 82, after establishing the connection, the customer may optionally establish a password for subsequent retrieval of the media file

At step 83, the customer is prompted to enter the sector, row number, and the number of seats to be photographed. The best positioned camera 30 is selected based on the input from the customer. To make the selection, a pre-compiled table is used, where each seat at the facility is pre-assigned to one or a few cameras. A step 84, if a particular camera is selected, the system checks if that camera is busy. If the camera is busy, then, at step 85, the system then selects another camera. Step 84 is repeated. At step 86, if all the cameras suitable to take the requested image, are busy, the current customer request is placed into the queue. At step 87, when the selected camera becomes available to take the picture, the information for the next customer which can be serviced using this camera is extracted from the queue. At step 88, based on the extracted request, the required angle and zoom data are read from the table. At step 89, the control functions of the camera 30 and rotating platform 32 is transferred to the mobile communication device 8. A menu of operation is provided which correlate the operating functions of the camera 31 and rotating platform 32 to at least one button of the communication device 8. At step 90, customer 7 takes control of the imaging system 2 via the mobile communication device 8. At step 91, customer composes at least one image, and taking the image (step 92) using a “shoot” function.

Throughout the image taking session, the image-taking system 2 is checking for the satisfying at least one of a plurality of conditions that would terminate the session. If any of such conditions is detected, the image taking system finishes the image taking session.

While FIGS. 1-8 illustratively describe exemplary components and devices that can be used to practice the exemplary systems and methods, according to specific embodiments of the present invention, it is clear that a person ordinarily skilled in the art can readily modify the demonstrated devices as well as the method steps for adaptation to application requirements consistent with the above descriptions. It should therefore be recognized that the present invention is not limited to the specific embodiments illustrated hereinabove, but rather extends in utility to many other modification, variation, application, and embodiment, and accordingly, all such modifications, variations, applications, and embodiments are to be regarded as being within the scope of the invention.

What is claimed is:

1. A media management system comprising:
a plurality of image-taking systems, each one of the image-taking systems comprising:
a camera having a plurality of control functions; and
a camera control unit for controlling operation of the camera; and
a system control unit including:
a communication unit for communicating with the plurality of image-taking systems and a mobile communication device, the communication unit establishing an image capturing session with the mobile communication device in response to an initiation by the mobile communication device; and
a processor that uses a location of the mobile communication device to select at least one image-taking system from the plurality of image-taking systems;
wherein the control unit transfers at least one of the plurality of control functions to the mobile communication device, and
wherein the mobile communication device operates the camera to capture at least one image.

2. The media management system of claim 1, wherein the camera control unit creates a media file by associating an identifier associated with the mobile communication device with at least one image captured by the camera of the selected image-taking system.

3. The media management system of claim 2, wherein the camera control unit transmits the media file to a server.

4. The image management system of claim 2, further comprising a media output terminal that receives from a customer the identifier associated with the mobile communication device; retrieves the media file corresponding to the identifier from the server; and transfers media from the media files to at least one of a printer, a storage media device and a computing device.

5. The media management system of claim 1, wherein the camera is mounted to an adjustable platform, the camera control unit controlling operation of the adjustable platform.

6. The image management system of claim 5, wherein the camera control unit transfers control of the adjustable platform to the mobile communication device.

7. The image management system of claim 1, wherein an image capturing session between the mobile communication device and the camera control unit is established when the mobile communication device dials a predetermined phone number of the camera control unit.

8. The image management system of claim 1, wherein the system control identifies the location of the mobile communication device and further wherein the communication unit transmits the location of the mobile communication device to the image-taking system.

9. The image management system of claim 8, wherein the system control determines the location of the mobile communication device via one of global positioning system and triangulation.

10. The image management system of claim 1, wherein the processor uses a signal from the mobile communication device to select the image capturing system.

11. The image management system of claim 1, wherein the camera control unit streams images captured by the selected camera to the mobile communication device.

12. The image management system of claim 1, wherein the control functions include at least one of zoom, pan, tilt, media capture, and time-elapse media capture.

13. The image management system of claim 1, wherein the mobile communication device creates an audio file, wherein the audio file is associated with the at least one image.

14. The image management system of claim 1, wherein the camera control unit generates a media file, the media file including the at least one image, an audio file and an identifier corresponding to the mobile communication device.

15. The image management system of claim 1, wherein the camera records at least one of a still image and a moving image.

16. The image management system of claim 1, wherein the mobile communication device is a cellular-enabled wireless device.

17. A method of controlling an image capturing device using a mobile communication device, the method comprising:
establishing, by a mobile communication device, an image capturing session with a system control unit;
selecting, by the system control unit at least one of a plurality of image-taking systems, each one of the image-taking systems comprising:
a camera having a plurality of control functions, and
a camera control unit for controlling operation of the camera;
transmitting, by the mobile communication device, to the system control unit, information relating to the location of the mobile communication device;
directing, by the system control unit, the camera in the direction of the location of the mobile communication device;
transmitting, by the camera control unit, to the mobile communication device, control functions for controlling operation of the camera;
capturing, by the camera, at least one image in response to operation by the mobile communication device; and
creating, by the image capturing system, a media file, the media file having the at least one image and an identifier associated with the mobile communication device.

18. The method of controlling an image capturing device of claim 17, further comprising streaming, by the camera control unit, the at least one image to the mobile communication device, prior to capturing the at least one image.

19. The method of controlling an image capturing device of claim 17, further comprising transmitting, by the image capturing system, the media file to a server.

20. The method of controlling an image capturing device of claim 17, further comprising retrieving, by an output terminal, the media file from the server, in response to an initiation session.
